(19) United States
(12) Patent Application Publication
(10) Pub. No.: US 2013/0050017 A1
(43) Pub. Date: Feb. 28, 2013

(54) SIDE LOBE SUPPRESSION METHOD FOR SYNTHETIC APERTURE RADAR (SAR) IMAGE

(71) Applicants: Yi Su, Changsha (CN); Huaijun Wang, Changsha (CN); Yu Li, Changsha (CN); Min Lu, Changsha (CN)

(72) Inventors: Yi Su, Changsha (CN); Huaijun Wang, Changsha (CN); Yu Li, Changsha (CN); Min Lu, Changsha (CN)

(73) Assignee: NATIONAL UNIVERSITY OF DEFENSE TECHNOLOGY, Changsha City, Hunan (CN)

(21) Appl. No.: 13/395,821

(22) PCT Filed: Apr. 29, 2011
(86) PCT No.: PCT/CN2011/073547

§ 371 Date: Mar. 13, 2012

(30) Foreign Application Priority Data
May 18, 2010 (CN) 201010175094.8

(51) Int. Cl. G01S 13/90

(52) U.S. Cl. 342/25 F

(57) ABSTRACT

A side lobe suppression method for an SAR image based on the deformation of a spatial spectral support area is provided. Using the relationship between the spatial spectral support area distribution of an SAR system and an impulse response, the trend of a side lobe in the impulse response is changed by deforming the spatial spectral support area; two SAR images with different side lobe trends are obtained by calculation; the difference information of the side lobe trends between the two SAR images is finally utilized to realize the mutual separation of a target main lobe and the side lobe, thus realizing effective side lobe suppression. The method has an obvious effect on side lobe suppression without losing image resolution, at the same time, can be realized simply, has less calculation amount, is not sensitive to noise, is also very convenient to implement, and can be directly used for processing an original SAR image.

This application claims priority to Chinese patent application No. 201010175094.8, titled “SIDE-LOBE SUPPRESSION METHOD FOR SAR IMAGE BASED ON SPECTRUM RESHAPING” and filed with the State Intellectual Property Office on May 18, 2010, which is herein incorporated by reference in its entirety.

### FIELD OF THE INVENTION

The present invention relates to the field of radar imaging technology, and in particular to a side-lobe suppression method for a synthetic aperture radar (SAR) image.

### BACKGROUND OF THE INVENTION

An SAR system can be modeled by a linear system, and the impulse response of a linear system can be described by a sinc function. Many of the important SAR image quality parameters can be assessed through the impulse response, such as PSLR (peak side-lobe ratio) and ISLR (integrated side-lobe ratio), both of which are associated with side-lobe performance. The PSLR determines the capability of a strong target to obscure nearby weaker targets. The ISLP indicates the degree of a local dark region in the SAR image being covered by the energy leakage from nearby bright regions.

The side-lobe performance directly affects the utilization of information in an SAR image. Especially in SAR image interpretation and target detection, an SAR image with a high side-lobe may lead to a significantly reduced capacity of the system to process a weak target; meanwhile, the accuracy of the detection of a strong target may be degraded due to side-lobe interference. An SAR image with a low side-lobe is favorable for visual detection, as well as the automatic or semi-automatic processing of information. In absence of side-lobe suppression, both PSLR and ISLR have large values, which are about −13 dB and −10 dB respectively.

In order to acquire an SAR image with a low side-lobe, various side-lobe suppression methods have been proposed. The methods can generally be classified into two categories: one reduces the level of a side-lobe using a linear weighting method, which may expand the main-lobe or lower the resolution; the other one uses some non-linear methods, which can maintain the image resolution. In comparison with a linear weighting method, most of the existing non-linear methods are complex and require a high computational load. Presently, the high side-lobe problem in SAR imaging has no effective solution. Therefore, it is desired in the development of the SAR system and the application of the SAR image to provide a simple and effective method for side-lobe suppression while maintaining the resolution.

### SUMMARY OF THE INVENTION

In order to solve the high side-lobe problem in an SAR image effectively, according to the present invention, it is provided a side-lobe suppression method for an SAR image based on reshaping of the coverage of a spatial spectrum. The method can realize effective side-lobe suppression without degrading the resolution; moreover, it is simple, requires little computational load, is not sensitive to noise, is easy to be implemented, and can be used directly on an original SAR image.

The inventors studied the relationship between the distribution of the coverage of a spatial spectrum of an SAR system and an impulse response of the SAR system, and found that reshaping of the coverage of a spatial spectrum can change the direction of a side-lobe of an impulse response, resulting in a corresponding change in the direction of a side-lobe of a target in the SAR image, while maintaining the information about the main-lobe. Therefore, the side-lobe direction difference between two SAR images can be used to separate the side-lobe and the main-lobe, and thus realizing effective side-lobe suppression.

The present invention provides a side-lobe suppression method for a synthetic aperture radar (SAR) image, including the following steps:

applying a two-dimensional Fourier transform to an original SAR image, to acquire a spatial spectrum of an SAR system;

extracting a coverage from the spatial spectrum of the SAR system, and reshaping the coverage of the spatial spectrum of the SAR system, to acquire a spatial spectrum of the SAR system with a reshaped coverage;

applying an inverse two-dimensional Fourier transform to the spatial spectrum of the SAR system with a reshaped coverage, to acquire a reshaped SAR image;

normalizing both the original SAR image and the reshaped SAR image;

calculating an image with main and side lobes superimposed and an image with side-lobes remaining according to the equations

$${e}_{s} ( x , y ) = \frac{1}{2} \vert \vert {e}^{⋒} ( x , y ) \vert + \vert 2 {{e}^{⋒}}^{′} ( x , y ) - {e}^{⋒} ( x , y ) \vert \vert , and$$

$${e}_{l} ( x , y ) = \frac{1}{2} \vert \vert {e}^{⋒} ( x , y ) \vert + \vert 2 {{e}^{⋒}}^{′} ( x , y ) - {e}^{⋒} ( x , y ) \vert \vert ,$$

respectively, where eₛ(x, y) is the image with main and side lobes superimposed, eₗ(x, y) is the image with side-lobes remaining where the main-lobe has been removed, ê(x, y) is the normalized original SAR image, and ê′(x, y) is the normalized reshaped SAR image; and

subtracting the image with side-lobes remaining from the image with main and side lobes superimposed, to acquire an SAR image with side-lobes suppressed.

Preferably, the coverage of the spatial spectrum of the SAR system is regularly shaped or irregularly shaped.

Preferably, the extracting a coverage from the spatial spectrum of the SAR system includes:

calculating a rectangular coverage of the spatial spectrum of the SAR system according to the equation

$$A ( {k}_{x} , {k}_{y} ) = \{ \begin{matrix}1 & {k}_{x , min} \leq {k}_{x} \leq {k}_{x , max} , {k}_{y , min} \leq {k}_{y} \leq {k}_{y , max} \\ 0 & otherwise ,\end{matrix}$$

k_{x,min}≦kₓ≦k_{x,max}, k_{y,min}≦k_{y}≦k_{y,max}, where A(kₓ,k_{y}) is the coverage of the spatial max spectrum of the SAR system, k_{x,min} and k_{x,max} denote a minimum and a maximum of the spatial spectrum of the SAR system in the kₓ direction respectively, and k_{y,min} and k_{y,max} denote a minimum and a maximum of the spatial spectrum of the SAR system in the k_{y} direction respectively.

Preferably, reshaping the coverage of the spatial spectrum of the SAR system, to acquire a spatial spectrum of the SAR system with a reshaped coverage includes:

reshaping the rectangular coverage of the spatial spectrum of the SAR system according to the equations A′(kₓ,k_{y})=A(kₓ,k_{y})F(kₓ,k_{y}),

$$F ( {k}_{x} , {k}_{y} ) = \{ \begin{matrix}1 , & {k}_{x , min} \leq {k}_{x} \leq 0 and - \frac{{k}_{y , min}}{{k}_{x , min}} {k}_{x} + {k}_{y , min} \leq {k}_{y} \leq - \frac{{k}_{y , max}}{{k}_{x , min}} {k}_{x} + {k}_{y , max} \\ 1 , & 0 \leq {k}_{x} \leq {k}_{x , max} and - \frac{{k}_{y , min}}{{k}_{x , max}} {k}_{x} + {k}_{y , min} \leq {k}_{y} \leq - \frac{{k}_{y , max}}{{k}_{x , max}} {k}_{x} + {k}_{y , max} \\ 0 , & other ,\end{matrix}$$

to acquire a spatial spectrum of the SAR system with a rhombus-shaped coverage, where A′(kₓ,k_{y}) is the reshaped spatial spectrum of the SAR system, F(kₓ,k_{y}) is the reshaping function, k_{x,min} and k_{x,max} denote the minimum and the maximum of the spatial spectrum of the SAR system in the kₓ direction respectively, and k_{y,min} and k_{y,max} denote the minimum and the maximum of the spatial spectrum of the SAR system in the k_{y} direction respectively.

It is also provided a side-lobe suppression method for a synthetic aperture radar (SAR) image, including the following steps:

1) acquisition of a spatial spectrum of an SAR system, including

applying a two-dimensional Fourier transform to an original SAR image e(x, y), to acquire a spatial spectrum E(kₓ,k_{y}) of an SAR system, according to the equation:

$$E ( {k}_{x} , {k}_{y} ) {\int }_{y} {\int }_{x} e ( x , y ) {e}^{- j ( {k}_{x} x + {k}_{y} y )} d x d y ;$$

2) reshaping of a coverage of the spatial spectrum, including

calculating a distribution function A(kₓ,k_{y}) of a coverage of the spatial spectrum of the SAR system according to the equation:

$$A ( {k}_{x} , {k}_{y} ) = \{ \begin{matrix}1 & {k}_{x , min} \leq {k}_{x} \leq {k}_{x , max} , {k}_{y , min} \leq {k}_{y} \leq {k}_{y , max} \\ 0 & otherwise ,\end{matrix}$$

where k_{x,min} and k_{x,max} denote a minimum and a maximum of the spatial spectrum of the SAR system in the kₓ direction respectively, and k_{y,min} and k_{y,max} denote a minimum and a maximum of the spatial spectrum of the SAR system in the k_{y} direaction respectively; and

reshaping the distribution function A(kₓ,k_{y}) of the coverage of the spatial spectrum according to the equation:

$${A}^{′} ( {k}_{x} , {k}_{y} ) = \frac{1}{2} A ( {k}_{x} - α {k}_{y} , {k}_{y} ) + \frac{1}{2} A ( {k}_{x} , {k}_{y} - β {k}_{x} )$$

$$where$$

$$α = \frac{{k}_{x , max - {k}_{x , min}}}{3 ( {k}_{y , max} - {k}_{y , min} )} , β = \frac{2 ( {k}_{x , max} - {k}_{x , min} )}{3 ( {k}_{y , max} - {k}_{y , min} )} ,$$

and A′(kₓ,k_{y}) is the distribution function of the reshaped coverage of the spatial spectrum;

3) generation of an SAR image and normalization, including

calculating a reshaped spatial spectrum E′(kₓ,k_{y}) of the SAR system from the distribution function A′(kₓ,k_{y}) of the reshaped coverage of the spatial spectrum of the SAR system, according to the equation E′(kₓ,k_{y})=A′(kₓ,k_{y})E(kₓ,k_{y});

applying an inverse two-dimensional Fourier transform to E′(kₓ,k_{y}) to acquire an SAR image e′(x, y) with the reshaped coverage of the spatial spectrum, according to the equation:

$${e}^{′} ( x , y ) = {\int }_{{k}_{y}} {\int }_{{k}_{x}} {E}^{′} ( {k}_{x} , {k}_{y} ) {e}^{j ( {k}_{x} x + {k}_{y} y )} d {k}_{x} d {k}_{y} ;$$

and

normalizing both the original SAR image e(x, y) and the reshaped SAR image e′(x, y), according to the equations:

$${e}^{⋒} ( x , y ) = \frac{e ( x , y )}{{max}_{x , y} \vert e ( x , y ) \vert} , {{e}^{⋒}}^{′} ( x , y ) = \frac{{e}^{′} ( x , y )}{{max}_{x , y} \vert {e}^{′} ( x , y ) \vert} ,$$

where e(x, y) and e′(x, y) become ê(x, y) and ê′(x, y) after the normalization, respectively;

4) separation of main-lobe and side-lobe, including

calculating an image with main and side lobes superimposed eₛ(x, y), according to the equation:

$${e}_{s} ( x , y ) = \frac{1}{2} \vert \vert {e}^{⋒} ( x , y ) \vert + \vert 2 {{e}^{⋒}}^{′} ( x , y ) - {e}^{⋒} ( x , y ) \vert \vert ;$$

and

calculating an image with side-lobes remaining eₗ(x, y) where the main-lobe has been removed, according to the equation:

$${e}_{l} ( x , y ) = \frac{1}{2} \vert \vert {e}^{⋒} ( x , y ) \vert - \vert 2 {{e}^{⋒}}^{′} ( x , y ) - {e}^{⋒} ( x , y ) \vert \vert ;$$

5) side-lobe suppression, including

subtracting the image with side-lobes remaining eₗ(x, y) from the image with main and side lobes superimposed eₛ(x, y), to acquire an SAR image with side-lobes suppressed eₘ(x, y), according to the equation: eₘ(x, y)=eₛ(x, y)−eₗ(x, y).

The present invention can bring the advantages below. The side-lobe direction difference between an SAR image after reshaping of the coverage of a spatial spectrum and the original SAR image before the reshaping is used to realize side-lobe suppression, which effectively suppresses the side-lobe without degrading the image resolution during the process of side-lobe suppression. Moreover, the process of the present invention merely relates to some simple arithmetic operations without the complication of complex operations such as inversion and eigendecomposition; hence, the present invention is simple, requires little computational load, is not sensitive to noise, is easy to be implemented, and can be used directly on an original SAR image.

### BRIEF DESCRIPTION OF THE DRAWINGS

FIG. 1 is a flowchart of a side-lobe suppression method for an SAR image according to the present invention;

FIG. 2 illustrates a spatial distribution of an SAR image ê(x, y) of a point target as calculated in a simulated test;

FIG. 3 illustrates a spatial distribution of an SAR image ê′(x, y) of a point target as calculated in a simulated test;

FIG. 4 illustrates a spatial distribution of an SAR image eₗ(x, y) of a point target as calculated in a simulated test; and

FIG. 5 illustrates a spatial distribution of an SAR image eₘ(x, y) of a point target as calculated in a simulated test.

### DETAILED DESCRIPTION OF THE EMBODIMENTS

A side-lobe suppression method for an SAR image according to the present invention will be described in details hereinafter in conjunction with the accompanying drawings.

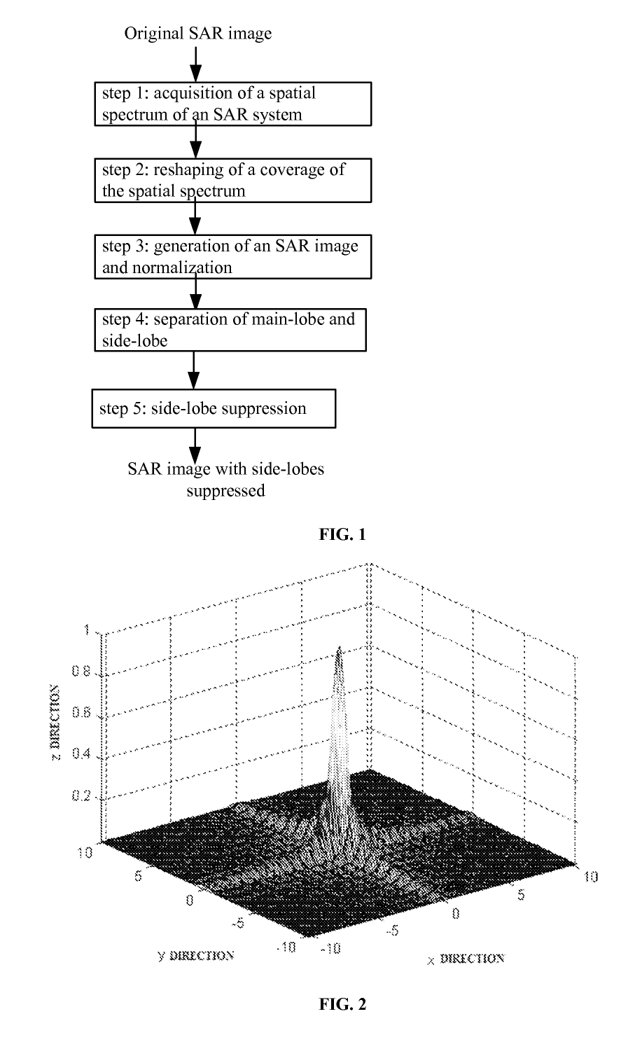

FIG. 1 is a flowchart of a side-lobe suppression method for an SAR image according to the present invention. In the figure, step 1 is acquisition of a spatial spectrum E(kₓ,k_{y}) of an SAR system, by applying a two-dimensional Fourier transform to an original SAR image e(x, y). Step 2 is reshaping of a coverage of the spatial spectrum, including calculating a distribution function A(kₓ,k_{y}) of the coverage of the spatial spectrum of the SAR system and reshaping the coverage of the spatial spectrum. Specifically, the calculating a distribution function of the coverage of the spatial spectrum of the SAR system includes the determination of the values of k_{x,min}, k_{x,max}, k_{y,min} and k_{y,max}; for details please refer to page 78 of “Radar Imaging Technology” (Bao Zheng et al., published by the Publishing House of Electronics Industry in 2005). Step 3 is generation of an SAR image and normalization, including: calculating the reshaped spatial spectrum E′(kₓ,k_{y}) of the SAR system, then applying an inverse two-dimensional Fourier transform to it to generate an SAR image e′(x, y) with the reshaped coverage of the spatial spectrum, and finally normalizing both the original SAR image and the SAR image with the reshaped coverage of the spatial spectrum. Step 4 is separation of main-lobe and side-lobe, including calculating an image with main and side lobes superimposed eₛ(x, y) and an image with side-lobes remaining eₗ(x, y). Step 5 is side-lobe suppression, including subtracting the image with side-lobes remaining eₗ(x, y) from the image with main and side lobes superimposed eₛ(x, y), to acquire a side-lobe suppression result eₘ(x, y).

An embodiment of the present invention provides a side-lobe suppression method for an SAR image. Specifically, the method includes the following steps.

Step 1: Acquisition of a Spatial Spectrum of an SAR System.

A two-dimensional Fourier transform is applied to an original SAR image e(x, y), to acquire a spatial spectrum E(kₓ,k_{y}) of an SAR system, according to the equation:

$$E ( {k}_{x} , {k}_{y} ) = {\int }_{y} {\int }_{x} e ( x , y ) {e}^{- j ( {k}_{x} x + {k}_{y} y )} d x d y .$$

Step 2: Reshaping of a Coverage of the Spatial Spectrum.

A distribution range of the spatial spectrum of the imaging system, i.e., a distribution function A(kₓ,k_{y}) of a coverage of the spatial spectrum, may be calculated from the spatial spectrum E(kₓ,k_{y}) of the original SAR image. Specifically, A(kₓ,k_{y})ε{0,1}, k_{x,min}≦kₓ, k_{x,max}, k_{y,min}, k_{y}≦k_{y,max}, where k_{x,min} and k_{x,max} denote a minimum and a maximum of the spatial spectrum of the SAR system in the kₓ direction respectively, and k_{y,min} and k_{y,max} denote a minimum and a maximum of the spatial spectrum of the SAR system in the k_{y} direction respectively. The coverage of the spatial spectrum represented by A(kₓ,k_{y}) may be regularly shaped, e.g., a rectangle, or irregularly shaped, e.g., fan-shaped or some combination of shapes such as a rectangle in combination with a trapezoid.

The distribution function A(kₓ,k_{y}) of the coverage of the spatial spectrum, which may have a shape as discussed above, is reshaped according to the equation: A′(kₓ,k_{y})=A(kₓ,k_{y})F(kₓ,k_{y})

In the equation above, A′(kₓ,k_{y}) is the distribution function of the reshaped coverage of the spatial spectrum, where A′⊂A; F(kₓ,k_{y}) is the reshaping function, where F(kₓ,k_{y})ε{0,1}, and the variable ranges are k_{x,min}≦kₓ≦k_{x,min}, k_{y,min}≦k_{y}≦k_{y,max}. It should be noted that, the embodiments of the present application may include converting a coverage of the spatial spectrum with any shape into any other shape. Neither the shape before the reshaping nor the shape after the reshaping is limited by the present application.

For illustrative purposes, an example is described below in which a rectangle-shaped coverage of the spatial spectrum is converted into a rhombus-shaped one.

When the shape of the coverage A(kₓ,k_{y}) of the spatial spectrum is a rectangle, then

$$A ( {k}_{x} , {k}_{y} ) = \{ \begin{matrix}1 & {k}_{x , min} \leq {k}_{x} \leq {k}_{x , max} , {k}_{y , min} \leq {k}_{y} \leq {k}_{y , max} \\ 0 & otherwise .\end{matrix}$$

In order to convert the rectangle-shaped coverage into a rhombus-shaped one with the maximum area, the reshaping function is:

$$F ( {k}_{x} , {k}_{y} ) = \{ \begin{matrix}1 , & {k}_{x , min} \leq {k}_{x} \leq 0 and - \frac{{k}_{y , min}}{{k}_{x , min}} {k}_{x} + {k}_{y , min} \leq {k}_{y} \leq - \frac{{k}_{y , max}}{{k}_{x , min}} {k}_{x} + {k}_{y , max} \\ 1 , & 0 \leq {k}_{x} \leq {k}_{x , max} and - \frac{{k}_{y , min}}{{k}_{x , max}} {k}_{x} + {k}_{y , min} \leq {k}_{y} \leq - \frac{{k}_{y , max}}{{k}_{x , max}} {k}_{x} + {k}_{y , max} \\ 0 , & other\end{matrix}$$

Step 3: Generation of an SAR Image and Normalization.

A reshaped spatial spectrum E′(kₓ,k_{y}) of the SAR system is calculated from the distribution function A′(kₓ,k_{y}) of the reshaped coverage of the spatial spectrum, according to the equation E′(kₓ,k_{y})=A′(kₓ,k_{y})E(kₓ,k_{y}).

An inverse two-dimensional Fourier transform is applied to E′(kₓ,k_{y}), to acquire an SAR image e′ (x, y) with the reshaped coverage of the spatial spectrum, according to the equation:

$${e}^{′} ( x , y ) = {\int }_{{k}_{y}} {\int }_{{k}_{x}} {E}^{′} ( {k}_{x} , {k}_{y} ) {e}^{j ( {k}_{x} x + {k}_{y} y )} d {k}_{x} d {k}_{y} .$$

Both the original SAR image e(x, y) and the reshaped SAR image e′(x, y) are normalized, according to the equations:

$${e}^{⋒} ( x , y ) = \frac{e ( x , y )}{{max}_{x , y} \vert e ( x , y ) \vert} , {{e}^{⋒}}^{′} ( x , y ) = \frac{{e}^{′} ( x , y )}{{max}_{x , y} \vert {e}^{′} ( x , y ) \vert} ,$$

where e(x, y) and e′(x, y) become e (x, y) and ê′(x, y) after the normalization, respectively.

Step 4: Separation of Main-Lobe and Side-Lobe.

Firstly, an image with main and side lobes superimposed eₛ(x, y) is calculated according to the equation:

$${e}_{s} ( x , y ) = \frac{1}{2} \vert \vert {e}^{⋒} ( x , y ) \vert + \vert 2 {{e}^{⋒}}^{′} ( x , y ) - {e}^{⋒} ( x , y ) \vert \vert .$$

Then, an image with side-lobes remaining eₗ(x, y) where the main-lobe has been removed is calculated by according to the equation:

$${e}_{l} ( x , y ) = \frac{1}{2} \vert \vert {e}^{⋒} ( x , y ) \vert - \vert 2 {{e}^{⋒}}^{′} ( x , y ) - {e}^{⋒} ( x , y ) \vert \vert$$

Step 5: Side-Lobe Suppression.

The image with side-lobes remaining is subtracted from the image with main and side lobes superimposed, to acquire an SAR image with side-lobes suppressed eₘ(x, y), according to the equation:

eₘ(x,y)=eₛ(x,y)−eₗ(x,y).

FIGS. 2-5 illustrate processing results of a simulated test according to an embodiment of the present invention, in which the unit of both the x-axis and the y-axis is meter, with the x direction representing the azimuth of the SAR image, the y direction representing the range of the SAR image and the z direction representing the magnitude of the normalized SAR image. Basic parameters in the simulated test are set as follows.

The transmit signal has a bandwidth of 200E+6 Hz and a center frequency of 10E+9 Hz; the vertical distance between the antenna and an ideal point target is 10E+3 meters; and the length of the synthetic aperture is 200 meters.

FIG. 2 illustrates a spatial distribution of an SAR image ê(x, y) of a point target as calculated in a simulated test. In the FIG. 2, the directions of the side-lobes in the SAR image ê(x, y) of the point target include the x direction and the y direction, i.e., the spatial distribution of the side-lobes is along the x coordinate direction and the y coordinate direction. The PSLRs in the x direction and in the y direction are both as large as −13.3 dB, and the ISLRs in the x direction and in the y direction are both as large as −10.1 dB. It can be seen that the level of the side-lobes of the SAR image without side-lobe suppression process is high.

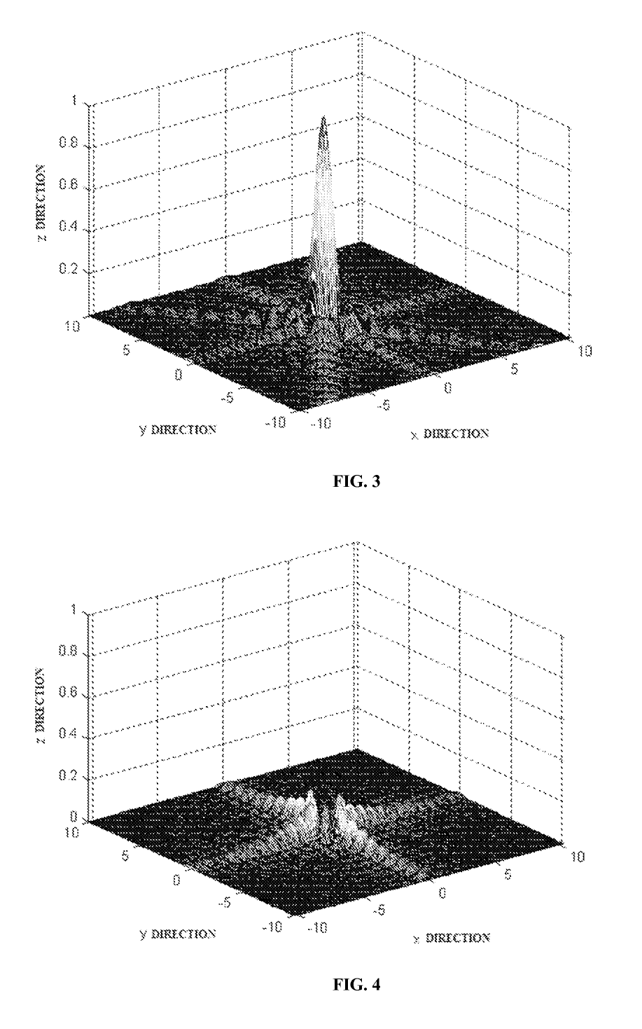

FIG. 3 illustrates a spatial distribution of an SAR image ê′(x, y) of a point target as calculated in a simulated test. It can be seen from FIG. 3 that the side-lobe directions are more complex. In addition to the x and y directions, the side-lobe directions also include those that are neither the x direction nor the y direction. Hence, there is certain difference information about the side-lobe directions between ê′(x, y) and ê(x, y).

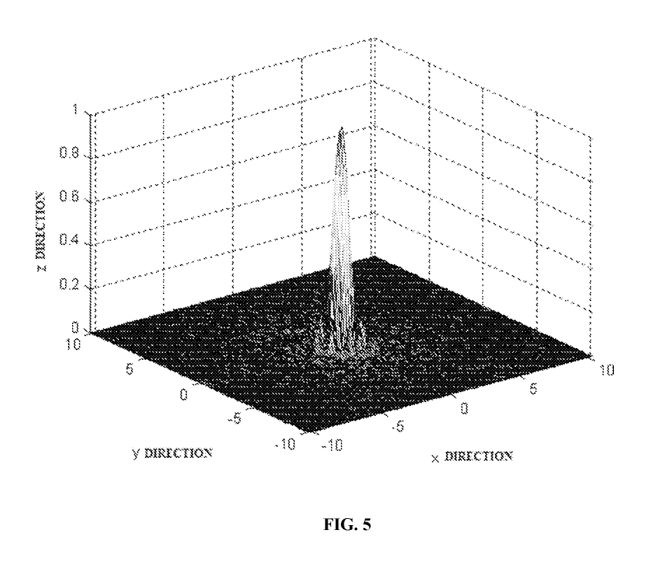

FIG. 4 illustrates a spatial distribution of an SAR image eₗ(x, y) of a point target as calculated in a simulated test. The SAR image eₗ(x, y) of the point target is mainly the side-lobe distribution of the SAR image ê′(x, y) of the point target, with the main-lobe of the SAR image ê(x, y) of the point target removed. That is, in eₗ(x, y), the side-lobes of ê(x, y) has been separated; thus, ê(x, y) may be referred to as an image with side-lobes remaining.

FIG. 5 illustrates a spatial distribution of an SAR image eₘ(x, y) of a point target as calculated in a simulated test. The SAR image eₘ(x, y) of the point target is the side-lobe suppression result obtained according to the method according to the present invention. As shown in the FIG. 5, most of the side-lobes of the SAR image eₘ(x, y) of the point target are suppressed, with only the main-lobe and little of the side-lobes left; therefore, the side-lobe suppression method for an SAR image based on reshaping of the coverage of a spatial spectrum does not degrade the image resolution. In the SAR image eₘ(x, y) of the point target, the PSLRs in the x direction and the y direction are reduced to −26.9 dB, and the ISLRs in the x direction and the y direction are reduced to −26.8 dB, which shows that the side-lobe suppression method for an SAR image according to the present invention has a good performance.

1. A side-lobe suppression method for a synthetic aperture radar (SAR) image, comprising:
applying a two-dimensional Fourier transform to an original SAR image, to acquire a spatial spectrum of an SAR system;
extracting a coverage from the spatial spectrum of the SAR system, and reshaping the coverage of the spatial spectrum of the SAR system, to acquire a spatial spectrum of the SAR system with a reshaped coverage;
applying an inverse two-dimensional Fourier transform to the spatial spectrum of the SAR system with a reshaped coverage, to acquire a reshaped SAR image;
normalizing both the original SAR image and the reshaped SAR image;
calculating an image with main and side lobes superimposed and an image with side-lobes remaining according to the equations
$${e}_{s} ( x , y ) = \frac{1}{2} \vert \vert {e}^{⋒} ( x , y ) \vert + \vert 2 {{e}^{⋒}}^{′} ( x , y ) - {e}^{⋒} ( x , y ) \vert \vert , and$$
$${e}_{l} ( x , y ) = \frac{1}{2} \vert \vert {e}^{⋒} ( x , y ) \vert - \vert 2 {{e}^{⋒}}^{′} ( x , y ) - {e}^{⋒} ( x , y ) \vert \vert ,$$
respectively, where eₛ(x, y) is the image with main and side lobes superimposed, eₗ(x, y) is the image with side-lobes remaining where the main-lobe has been removed, ê(x, y) is the normalized original SAR image, and ê′(x, y) is the normalized reshaped SAR image; and
subtracting the image with side-lobes remaining from the image with main and side lobes superimposed, to acquire an SAR image with side-lobes suppressed.

2. The side-lobe suppression method for an SAR image according to claim 1, wherein the coverage of the spatial spectrum of the SAR system is regularly shaped or irregularly shaped.

3. The side-lobe suppression method for an SAR image according to claim 1, wherein the extracting a coverage from the spatial spectrum of the SAR system comprises:
calculating a rectangular coverage of the spatial spectrum of the SAR system according to the equation
$$A ( {k}_{x} , {k}_{y} ) = \{ \begin{matrix}1 & {k}_{x , min} \leq {k}_{x} \leq {k}_{x , max} , {k}_{y , min} \leq {k}_{y} \leq {k}_{y , max} \\ 0 & otherwise ,\end{matrix}$$
k_{x,min}≦kₓ≦k_{x,max}, k_{y,min}≦k_{y}≦k_{y,max}, where A(kₓ,k_{y}) is the coverage of the spatial spectrum of the SAR system, k_{x,min} and k_{x,max} denote a minimum and a maximum of the spatial spectrum of the SAR system in the kₓ direction respectively, and k_{y,min} and k_{y,max} denote a minimum and a maximum of the spatial spectrum of the SAR system in the k_{y} direction respectively.

4. The side-lobe suppression method for an SAR image according to claim 3, wherein reshaping the coverage of the spatial spectrum of the SAR system, to acquire a spatial spectrum of the SAR system with a reshaped coverage comprises:
reshaping the rectangular coverage of the spatial spectrum of the SAR system according to the equations A′(kₓ,k_{y})=A(kₓ,k_{y})F(kₓ,k_{y}),
$$F ( {k}_{x} , {k}_{y} ) = \{ \begin{matrix}1 , & {k}_{x , min} \leq {k}_{x} \leq 0 and - \frac{{k}_{y , min}}{{k}_{x , min}} {k}_{x} + {k}_{y , min} \leq {k}_{y} \leq - \frac{{k}_{y , max}}{{k}_{x , min}} {k}_{x} + {k}_{y , max} \\ 1 , & 0 \leq {k}_{x} \leq {k}_{x , max} and - \frac{{k}_{y , min}}{{k}_{x , max}} {k}_{x} + {k}_{y , min} \leq {k}_{y} \leq - \frac{{k}_{y , max}}{{k}_{x , max}} {k}_{x} + {k}_{y , max} \\ 0 , & other ,\end{matrix}$$
to acquire a spatial spectrum of the SAR system with a rhombus-shaped coverage, where A′(kₓ,k_{y}) is the reshaped spatial spectrum of the SAR system, F(kₓ,k_{y}) is the reshaping function, k_{x,min} and k_{x,max} denote the minimum and the maximum of the spatial spectrum of the SAR system in the kₓ direction respectively, and k_{y,min} and k_{y,max} denote the minimum and the maximum of the spatial spectrum of the SAR system in the k_{y} direction respectively.

5. A side-lobe suppression method for a synthetic aperture radar (SAR) image, comprising:
1) acquisition of a spatial spectrum of an SAR system, comprising
applying a two-dimensional Fourier transform to an original SAR image e(x, y), to acquire a spatial spectrum E(kₓ,k_{y}) of an SAR system;
2) reshaping of a coverage of the spatial spectrum, comprising
calculating a distribution function A(kₓ, k_{y}) of a coverage of the spatial spectrum of the SAR system according to the equation:
$$A ( {k}_{x} , {k}_{y} ) = \{ \begin{matrix}1 & {k}_{x , min} \leq {k}_{x} \leq {k}_{x , max} , {k}_{y , min} \leq {k}_{y} \leq {k}_{y , max} \\ 0 & otherwise ,\end{matrix}$$
where k_{x,min} and k_{x,max} denote a minimum and a maximum of the spatial spectrum of the SAR system in the kₓ direction respectively, and k_{y,min} and k_{y,max} denote a minimum and a maximum of the spatial spectrum of the SAR system in the k_{y} direction respectively; and
reshaping the distribution function A(kₓ,k_{y}) of the coverage of the spatial spectrum according to the equation:
$${A}^{′} ( {k}_{x} , {k}_{y} ) = \frac{1}{2} A ( {k}_{x} - α {k}_{y} , {k}_{y} ) + \frac{1}{2} A ( {k}_{x} , {k}_{y} - β {k}_{x} ) where$$
$$α = \frac{{k}_{x , max} - {k}_{x , min}}{3 ( {k}_{y , max} - {k}_{y , min} )} , β = \frac{2 ( {k}_{x , max} - {k}_{x , min} )}{3 ( {k}_{y , max} - {k}_{y , min} )} ;$$
3) generation of an SAR image and normalization, comprising
E′(kₓ,k_{y})=A′(kₓ,k_{y})E(kₓ,k_{y});
applying an inverse two-dimensional Fourier transform to E′(kₓ,k_{y}) to acquire an SAR image e′(x, y) with the reshaped coverage of the spatial spectrum; and
normalizing both the original SAR image e(x, y) and the reshaped SAR image e′(x, y), where e(x, y) and e′(x, y) become ê(x, y) and ê′(x, y) after the normalization, respectively;
4) separation of main-lobe and side-lobe, comprising
calculating an image with main and side lobes superimposed eₛ(x, y), according to the equation:
$${e}_{s} ( x , y ) = \frac{1}{2} \vert \vert {e}^{⋒} ( x , y ) \vert + \vert 2 {{e}^{⋒}}^{′} ( x , y ) - {e}^{⋒} ( x , y ) \vert \vert ;$$
and
calculating an image with side-lobes remaining eₗ(x, y) where the main-lobe has been removed, according to the equation:
$${e}_{l} ( x , y ) = \frac{1}{2} \vert \vert {e}^{⋒} ( x , y ) \vert - \vert 2 {{e}^{⋒}}^{′} ( x , y ) - {e}^{⋒} ( x , y ) \vert \vert ;$$
5) side-lobe suppression, comprising
subtracting the image with side-lobes remaining eₗ(x, y) from the image with main and side lobes superimposed eₛ(x, y) to acquire an SAR image with side-lobes suppressed eₘ(x, y).
